(19) United States
(12) Patent Application Publication
(10) Pub. No.: US 2024/0128470 A1
(43) Pub. Date: Apr. 18, 2024

(54) COMPOSITION FOR A POROUS TRANSPORT LAYER, A POROUS TRANSPORT LAYER PREPARED THEREFROM, AND A METHOD FOR PREPARING THE SAME

(71) Applicants: HYUNDAI MOTOR COMPANY, Seoul (KR); KIA CORPORATION, Seoul (KR)

(72) Inventor: Young June Park, Yangseo-myeon (KR)

(73) Assignees: HYUNDAI MOTOR COMPANY, Seoul (KR); KIA CORPORATION, Seoul (KR)

(21) Appl. No.: 18/101,774

(22) Filed: Jan. 26, 2023

(30) Foreign Application Priority Data
Oct. 17, 2022 (KR) 10-2022-0133297

(51) Int. Cl. H01M 4/88; C25B 1/04; C25B 11/032; C25B 11/063

(52) U.S. Cl. CPC H01M 4/8807; C25B 1/04; C25B 11/032; C25B 11/063; H01M 2004/8684

(57) ABSTRACT

A composition for a porous transport layer, a porous transport layer prepared therefrom, and a method for preparing the same are disclosed. The composition for the porous transport layer includes a titanium group element, a solvent, and a foaming agent.

### CROSS-REFERENCE TO RELATED APPLICATION

This application claims the benefit of priority to Korean Patent Application No. 10-2022-0133297, filed in the Korean Intellectual Property Office on Oct. 17, 2022, the entire contents of which are incorporated herein by reference.

### TECHNICAL FIELD

The present disclosure relates to a composition for a porous transport layer, a porous transport layer prepared therefrom and containing coarse pores such that water may flow smoothly into the layer and oxygen gas may be smoothly discharged from the layer, and a method for preparing the same.

### BACKGROUND

A polymer electrolyte membrane (PEM) water electrolysis system is an electro-chemical conversion device that decomposes water (H₂O) into hydrogen (H₂) and oxygen (O₂) using electricity. The PEM water electrolysis system may be operated at a high current density, may produce high-purity hydrogen and oxygen because a gas permeability via a solid electrolyte membrane is low, and may have high stability. Such PEM water electrolysis system is composed of a PEM water electrolysis stack and a peripheral device for driving the same, and the PEM water electrolysis stack is composed of a plurality of PEM water electrolysis cells.

### SUMMARY

The present disclosure has been made to solve the above-mentioned problems occurring in the prior art while advantages achieved by the prior art are maintained intact.

An aspect of the present disclosure provides a composition for a porous transport layer, a porous transport layer prepared therefrom and containing coarse pores such that water may flow smoothly into the layer and oxygen gas may be smoothly discharged from the layer, and a method for preparing the same.

The technical problems to be solved by the present disclosure are not limited to the aforementioned problems. Any other technical problems not mentioned herein should be clearly understood from the following description by those having ordinary skill in the art to which the present disclosure pertains.

According to an aspect of the present disclosure, a composition for a porous transport layer contains a titanium group element, a solvent, and a foaming agent.

According to another aspect of the present disclosure, a porous transport layer is prepared from the composition for the porous transport layer and contains coarse pores with an average pore diameter equal to or greater than 45 micrometers (μm).

According to another aspect of the present disclosure, a water electrolysis cell or a fuel cell includes the porous transport layer.

According to another aspect of the present disclosure, a method for preparing a porous transport layer includes preparing the porous transport layer by applying a composition for the porous transport layer containing a titanium group element, a solvent, and a foaming agent.

### BRIEF DESCRIPTION OF THE DRAWINGS

The above and other objects, features, and advantages of the present disclosure should become more apparent from the following detailed description taken in conjunction with the accompanying drawings:

FIG. 1 is a cross-sectional view of an example of a polymer electrolyte membrane (PEM) water electrolysis cell; and

FIG. 2 is a cross-sectional view of a porous transport layer according to an embodiment of the present disclosure.

### DETAILED DESCRIPTION

Herein, when a certain portion “includes” a certain component, this means that the certain portion may further include other components without excluding said other components unless otherwise stated.

Herein, when a first member is located on a “surface,” “one surface,” “the other surface,” or “both surfaces” of a second member, this includes not only a case in which the first member is in contact with the second member, but also a case in which a third member exists between the two members.

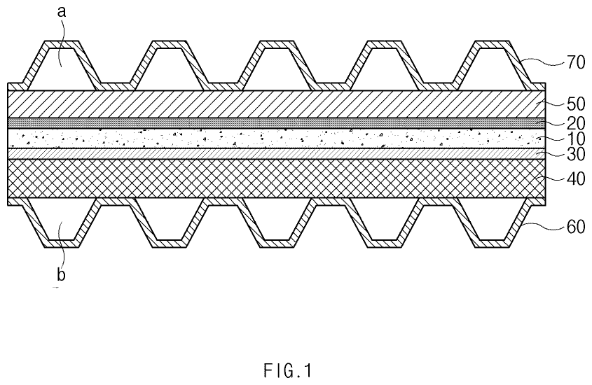

Referring to FIG. 1, a polymer electrolyte membrane (PEM) water electrolysis cell may include a membrane-electrode assembly (MEA) including an electrolyte membrane 10, an anode 20, a cathode 30, a gas diffusion layer (GDL) 40 for the cathode, a porous transport (PTL) 50 for the anode, a separator 60 for the cathode, and a separator 70 for the anode. In this regard, water introduced via a separator flow path ‘a’ for the anode is supplied to the anode 20 via the PTL 50, and hydrogen gas generated at the cathode 30 is discharged via the GDL 40 and a separator flow path ‘b’ for the cathode. In an electrochemical reaction of such PEM water electrolysis cell, after the water supplied to the anode is separated into hydrogen ions (H⁺) and electrons together with oxygen gas by an oxygen evolution reaction (OER), the hydrogen ions (H⁺) and the electrons move to the cathode via the electrolyte membrane and an external circuit, respectively, and generate the hydrogen gas by a hydrogen evolution reaction.

The PTL uniformly distributes and/or diffuses the water as a reactant onto a surface of the anode, discharges the oxygen generated at the anode to the outside via the separator, and collects and/or transports the electrons generated by the electrochemical reaction. To maximize such functions of the PTL, various physical properties such as corrosion resistance, electrical conductivity, distributivity and diffusivity, low surface roughness, mechanical strength, and the like are essential. In this regard, for the PTL, materials with excellent electrical conductivity, thermal conductivity, and corrosion resistance and low mass transport losses are desirable. Accordingly, it is common that a conventional PLT is made of titanium (Ti) having excellent physical and chemical properties because corrosion does not occur even under high potential and acidic conditions.

When the oxygen produced by the OER at the anode is not rapidly discharged from the PTL, the oxygen interferes with a flow of water newly introduced for the reaction and reduces an area of contact with the MEA, which inhibits a chemical reaction of a water electrolysis system and causes performance degradation. Accordingly, there is a need for research and development on a porous transport layer from which the oxygen gas generated by the OER at the anode may be smoothly discharged and into which the water for the reaction may be smoothly introduced, and a method for preparing the same.

### Composition for Porous Transport Layer

A composition for the porous transport layer according to the present disclosure contains a titanium group element, a solvent, and a foaming agent.

### Titanium Group Element

The titanium group element may include titanium, zirconium, hafnium, or a combination thereof. Specifically, the titanium group element may include the titanium.

The titanium group element may be used without any particular limitation as long as it is in a form that may be used in preparing the PTL and, for example, may be in a circular, oval, amorphous, or fibrous form.

In addition, the titanium group element in the composition may have an average size of particles in a range from 10 to 80 micrometers (μm), from 25 to 45 μm, or from 55 to 80 μm. When the average size of the particles of the titanium group element is lower than the above range, a porosity of the prepared porous transport layer may be too low, and rigidity thereof may be low. When the average size of the particles exceeds the above range, the porosity of the prepared porous transport layer may be too high and roughness thereof may be high, so that a problem of low performance may occur because of high resistance. In this regard, an average particle diameter of the particles may be a particle diameter of cumulative distribution 50% (D₅₀) in a particle diameter distribution measured using a particle size analyzer (PSA).

The titanium group element may be contained in the composition in an amount of 40 to 90 parts by weight, 45 to 85 parts by weight, or 55 to 80 parts by weight based on 2 to 10 parts by weight of a solvent. When the content of the titanium group element is lower than the above range, there may be a problem that sintering is not performed because of a long distance between titanium during a heat treatment process or the porosity of the prepared porous transport layer is too high. In addition, when the content of the titanium group element exceeds the above range, the porosity of the prepared porous transport layer may be too low.

### Solvent

The solvent may be used without any particular limitation as long as it is a solvent that may be used in preparing the PTL and, for example, may be ethanol, toluene, and the like.

In addition, the solvent may be contained in the composition in an amount of 2 to 10 parts by weight, 3 to 8 parts by weight, or 4 to 7 parts by weight, based on 40 to 90 parts by weight of the titanium group element. When the content of the solvent is lower than the above range, a coating property of the composition may be lowered, and a thickness of the porous transport layer may be uneven or a porosity deviation may occur. When the content of the solvent exceeds the above range, contamination of materials and equipment may occur because of excessive evaporation of the solvent during the sintering.

### Foaming Agent

The foaming agent may be a pyrolytic chemical foaming agent. When the foaming agent is the pyrolytic chemical foaming agent, in the preparation of the porous transport layer, the foaming agent may be pyrolyzed and removed and only coarse pores may remain in the porous transport layer during the sintering.

Specifically, the pyrolytic chemical foaming agent may include Azobisisobutyronitrile (AIBN), p-Toluenesulfonylhydrazide (TSH), Oxybisbenzene sulfonhydrazide (OBSH), 1,1′-Anobiscyclohexane carbonitrile (ACHN), or a combination thereof.

In addition, the foaming agent may be subjected to a surface treatment using a hydrophilic resin. When using the foaming agent that has been subjected to the surface treatment using the hydrophilic resin as the foaming agent, the coarse pores formed by the foaming agent may have hydrophilicity, so that the water, which is the reactant, may be introduced more easily than the oxygen gas, which is a product. In this regard, the hydrophilic resin may be used without any particular limitation as long as it is a polymer having a hydrophilicity in general and, for example, may be a polyolefin-based or polyurethane-based resin, but may not be limited thereto.

The foaming agent may be in a granular form, and an average diameter thereof may be in a range from 50 μm to 1 millimeter (mm), from 60 to 800 μm, or from 80 to 200 μm. When the average diameter of the foaming agent is within the above range, because an average diameter of the coarse pores in the porous transport layer is appropriate, the water introduction and the oxygen discharge may become easier. On the other hand, when the average diameter of the foaming agent is lower than the above range, a size of the pores in the porous transport layer becomes too small, which causes difficulties in discharging fluid, which is a role of the pores. When the average diameter of the foaming agent exceeds the above range, the size of the pores in the porous transport layer (PTL) becomes too large, so that the fluid may flow only to a corresponding region, and the oxygen discharge, which is another role of the pores of the PTL, may become difficult.

In addition, the foaming agent may be contained in the composition in an amount of 5 to 40 parts by weight, 10 to 40 parts by weight, or 15 to 30 parts by weight based on 40 to 90 parts by weight of the titanium group element. When the content of the foaming agent is lower than the above range, the average diameter of the pores in the prepared porous transport layer may be small, so that the water introduction and the oxygen gas discharge may not be easy. When the content of the foaming agent exceeds the above range, the average diameter of the pores in the prepared porous transport layer may become excessively large, so that the water, which is the inflowing fluid, may not be properly diffused.

The composition for the porous transport layer may further contain a dispersant and a binder.

### Dispersant

The dispersant may be used without any particular limitation as long as it may be used in preparing the PTL and, for example, may include water, methanol, isopropanol, xylene, cyclohexanone, acetone, methyl ethyl ketone, or a combination thereof.

In addition, the dispersant may be contained in the composition in an amount of 0.1 to 3 parts by weight, 1 to 3 parts by weight, or 1.5 to 2.3 parts by weight, based on 40 to 90 parts by weight of the titanium group element. When the content of the dispersant in the composition is lower than the above range, the particles of the titanium group element may agglomerate during the composition preparation. When the content of the dispersant in the composition exceeds the above range, viscosity of the composition may be too low to perform a coating process, and thus, insufficient workability may occur.

### Binder

The binder may be used without any particular limitation as long as it may be used in preparing the PTL and for example, may include polyvinyl butyral (PVB), polyvinyl alcohol (PVA), polyvinyl chloride (PVC), polyvinyl acetate (PVAc), polyacrylonitrile, or a combination thereof.

In addition, the binder may be contained in the composition in an amount of 0.1 to 4 parts by weight, 1 to 4 parts by weight, or 1.5 to 3 parts by weight, based on 40 to 90 parts by weight of the titanium group element. When the content of the binder in the composition is lower than the above range, it may be difficult to maintain a sheet shape because of insufficient binding force between the particles of the titanium group element in the prepared porous transport layer. When the content of the binder in the composition exceeds the above range, a binding force between components in the composition may be strong, so that the components may be attached to a lower substrate during the coating process.

The composition for the porous transport layer may be prepared by stirring, specifically, mixing, in a ball mill process, the titanium group element, the solvent, and the foaming agent with each other. In this regard, a stirring time may be 30 minutes or longer, 1 to 30 hours, or 1 to 24 hours, but this may not be limited thereto, and may be a time for uniform mixing.

### Porous Transport Layer

The porous transport layer according to the present disclosure is prepared from the composition for the porous transport layer and contains the coarse pores with an average pore diameter equal to or greater than 45 μm.

Specifically, the porous transport layer may contain fine pores with an average pore diameter in a range from 10 to 40 μm and the coarse pores with an average pore diameter in a range from 45 to 800 μm. More specifically, the porous transport layer may contain the fine pores with an average pore diameter in a range from 20 to 40 μm and the coarse pores with an average pore diameter in a range from 50 to 200 μm. The average pore diameters of the fine pores and the coarse pores may be values measured using a mercury intrusion pore analysis method.

In this regard, the pores are all fluid pathways that diffuse the water, which is a reactive fluid, to be evenly reacted into a surface of the MEA and reacted, and remove the oxygen, which is a product fluid. Among the pores, the fine pores may mainly serve to properly diffuse the introduced water, and the coarse pores may serve to discharge the generated oxygen.

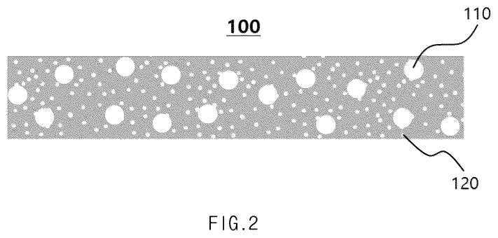

Referring to FIG. 2, a porous transport layer 100 according to the present disclosure contains coarse pores 110 and fine pores 120.

The porous transport layer may have an average porosity in a range from 30 to 80% or from 40 to 65%. In this regard, the average porosity may be a value measured using mercury intrusion pore analysis equipment.

In addition, the porous transport layer may have an average pore diameter in a range from 30 to 100 μm, from 35 to 90 μm, or from 40 to 85 μm. In this regard, the average pore diameter may be a value measured using the mercury intrusion pore analysis equipment.

The porous transport layer may have an average thickness in a range from 300 to 1,000 μm or from 500 to 800 μm. The porous transport layer according to the present

disclosure as described above may be suitably used as a material for the water electrolysis cell or a fuel cell because the porous transport layer has remarkably excellent performance as the water, which is the reactant, smoothly flows thereinto and the oxygen gas, which is the product, is smoothly discharged therefrom.

### Water Electrolysis Cell or Fuel Cell

The water electrolysis cell or the fuel cell of the present disclosure contains the porous transport layer as described above.

For example, the membrane-electrode assembly (MEA) may be stacked on one surface of the porous transport layer and the separator for the anode may be stacked on the other surface of the porous transport layer.

### Method for Preparing Porous Transport Layer

The method for preparing the porous transport layer according to the present disclosure includes preparing the porous transport layer by applying the composition for the porous transport layer.

The application process may include tape casting, comma coating, doctor blade coating, web coating, slot die coating, gravure coating, lip coating, cap coating, bar coating, or a combination thereof.

This step includes preparing a base layer by applying the composition for the porous transport layer and drying, degreasing, and sintering the base layer to prepare the porous transport layer.

### Drying

A green sheet may be manufactured by evaporating a portion of the solvent in the porous transport layer via the drying.

In addition, the drying may be performed at a temperature lower than a pyrolysis temperature of the pyrolytic chemical foaming agent. Specifically, the drying may be performed in a range from 60 to 90° C. or from 70 to 80° C. When the drying temperature is lower than the above range, the solvent may not be evaporated and thus the material may be contaminated. When the drying temperature exceeds the above range, economic efficiency may be lowered because of a small effect compared to the temperature.

### Degreasing

The degreasing may be performed at a temperature capable of removing the solvent in the green sheet. For example, the degreasing may be performed in a range from 500 to 800° C., from 600 to 800° C., or from 600 to 750° C. under an inert gas atmosphere. In this regard, the usable inert gas may be an inert gas, and, for example, may be argon (Ar) gas.

When the temperature during the degreasing treatment is lower than the above range, the solvent may remain without being entirely evaporated. When the temperature during the degreasing treatment exceeds the above range, the titanium group element in the porous transport layer may be oxidized as the sintering temperature is reached in a non-vacuum atmosphere.

### Sintering

The sintering may be performed at a temperature and a pressure applicable to the preparation of the PTL and, for example, may be performed at a temperature equal to or higher than the pyrolysis temperature of the pyrolytic chemical foaming agent. For this reason, the foaming agent may be pyrolyzed and removed by the sintering, and only the coarse pores may remain in the porous transport layer.

The sintering may be performed at a temperature in a range from 900 to 1,500° C. or from 1,000 to 1,300° C., and at a vacuum degree equal to or lower than 1×10⁻⁵ Torr, in a range from 1×10⁻⁸ to 1×10⁻⁵ Torr or from 1×10⁻⁷ to 5×10⁻⁶ Torr.

When the temperature during the sintering is lower than the above range, the titanium group element may not be sintered. When the temperature during the sintering exceeds the above range, the titanium group element may be excessively sintered, causing clogged pores or excessive thickness deviation.

In addition, when the vacuum degree during the sintering is lower than the above range, the titanium group element may be oxidized at a high temperature. When the vacuum degree during the sintering exceeds the above range, a process cost may increase because a vacuum pump of a high-spec more than necessary is required.

Hereinafter, the present disclosure is described in more detail through Examples. However, such Examples are intended to help the understanding of the present disclosure, and the scope of the present disclosure is not limited to such Examples in any way.

### EXAMPLES

### Example 1. Preparation of Composition for Porous Transport Layer

A composition-1 for the porous transport layer was prepared by mixing 70% by weight of titanium with an average size of the particles of 35 μm, 7% by weight of ethanol as the solvent, 2% by weight of isopropanol as the dispersant, 2% by weight of polyvinyl butyral as the binder, and 19% by weight of Azobisisobutyronitrile (AIBN) with an average size of the particles of 120 μm as the foaming agent with each other.

### Examples 2-4 and Comparative Example 1

Compositions for the porous transport layer were prepared in the same manner as in Example 1, except that an element ratio of the composition was adjusted as shown in Table 1.

TABLE 1

| (% by | | | | Polyvinyl | Azobisiso- |
|---|---|---|---|---|---|
| weight) | Titanium | Ethanol | Isopropanol | Butyral | butyronitrile |
| Example 1 | 70 | 7 | 2 | 2 | 19 |
| Example 2 | 59 | 7 | 2 | 2 | 30 |
| Example 3 | 86 | 7 | 2 | 2 | 3 |
| Example 4 | 39 | 7 | 2 | 2 | 50 |
| Compara- | 89 | 7 | 2 | 2 | — |
| tive | | | | | |
| Example 1 | | | | | |

### Experimental Example 1. Performance Evaluation

The compositions for the porous transport layer of Examples 1-4 and Comparative Example 1 were applied in the tape casting process and then dried at 80° C. for 20 minutes. Thereafter, the compositions were degreased under an argon gas atmosphere and at 650° C. for 200 minutes and sintered at a vacuum degree of 2×10⁻⁶ and a temperature of 1050° C. for 120 minutes to prepare porous transport layers with an average thickness of 500 μm.

Gas and water permeabilities, an average pore size, and a porosity were measured for each of the prepared porous transport layers, and a result thereof is shown in Table 2.

Specifically, for the gas or water permeability, a flow rate of each fluid (the oxygen or the water) penetrating the PTL was measured below the PTL while allowing the oxygen as a gas or the water to flow from above the PTL at a pressure of 2 psi in a state in which the porous transport layer is cut to a size of 10 cm×10 cm and then sealed using a gasket.

In addition, the average pore diameter and porosity were measured using the mercury intrusion pore size analysis equipment using the mercury intrusion method.

TABLE 2

| | Gas | Water | Average pore | |
|---|---|---|---|---|
| | permeability | permeability | diameter | Porosity |
| | (L/min) | (10⁻³ darcy) | (μm) | (%) |
| Example 1 | 20.91 | 9.90 | 42.1 | 42 |
| Example 2 | 42.67 | 11.96 | 84.6 | 62 |
| Example 3 | 6.74 | 6.59 | 27.7 | 36 |
| Example 4 | 127.13 | 22.69 | 105.1 | 76 |
| Comparative | 3.51 | 3.27 | 11.7 | 27 |
| Example 1 | | | | |

As shown in Table 2, it may be seen that Examples 1-4 contain the foaming agent to have excellent gas and water permeabilities and have appropriate average pore diameter and porosity. Thus, the water for the reaction may be smoothly introduced thereinto and the oxygen gas generated by the reaction may be smoothly discharged therefrom.

On the other hand, Comparative Example 1 not containing the foaming agent has low gas and water permeabilities because of insufficient average pore diameter and porosity. Thus, there was a concern that the performance of the water electrolysis cell or the fuel cell including the same may be deteriorated.

The composition for the porous transport layer according to the present disclosure may contain the foaming agent so as to prepare the porous transport layer containing the coarse pores. Such porous transport layer containing the coarse pores may have remarkably excellent performance as the water for the reaction may smoothly flow thereinto and the oxygen gas generated by the reaction may be smoothly discharged therefrom.

In addition, the water electrolysis cell or the fuel cell according to the present disclosure, containing the porous transport layer, has remarkably excellent oxygen evolution reaction performance.

Hereinabove, although the present disclosure has been described with reference to various embodiments and the accompanying drawings, the present disclosure is not limited thereto. The disclosed embodiments may be variously modified and altered by those having ordinary skill in the art to which the present disclosure pertains without departing from the spirit and scope of the present disclosure claimed in the following claims.

What is claimed is:

1. A composition for a porous transport layer, the composition comprising:
a titanium group element;
a solvent; and
a foaming agent.

2. The composition of claim 1, wherein the titanium group element comprises titanium, zirconium, hafnium, or a combination thereof.

3. The composition of claim 1, wherein the foaming agent is a pyrolytic chemical foaming agent.

4. The composition of claim 3, wherein the pyrolytic chemical foaming agent comprises Azobisisobutyronitrile (AIBN), p-Toluenesulfonylhydrazide (TSH), Oxybisbenzene sulfonhydrazide (OBSH), 1,1′-Anobiscyclohexane carbonitrile (ACHN), or a combination thereof.

5. The composition of claim 1, wherein the foaming agent is in a granular form and has an average diameter in a range from 50 micrometers (μm) to 1 millimeter (mm).

6. The composition of claim 1, wherein the composition comprises:
40 to 90 parts by weight of the titanium group element;
2 to 10 parts by weight of the solvent; and
5 to 40 parts by weight of the foaming agent.

7. The composition of claim 1, further comprising:
a dispersant; and
a binder.

8. The composition of claim 6, wherein the composition further comprises:
0.1 to 3 parts by weight of a dispersant; and
0.1 to 4 parts by weight of a binder,
with respect to 40 to 90 parts by weight of the titanium group element.

9. A porous transport layer comprising:
a composition having a titanium group element, a solvent, and a foaming agent,
wherein the porous transport layer contains coarse pores with an average pore diameter equal to or greater than 45 micrometers (μm).

10. The porous transport layer of claim 9, wherein the porous transport layer further contains fine pores with an average pore diameter in a range from 10 to 40 μm, and
wherein the coarse pores have an average pore diameter in a range from 45 to 800 μm.

11. The porous transport layer of claim 9, wherein an average porosity of the porous transport layer is in a range from 30 to 80%.

12. A water electrolysis cell or a fuel cell including the porous transport layer of claim 9.

13. A method for preparing a porous transport layer, the method comprising:
preparing the porous transport layer by applying a composition for the porous transport layer containing a titanium group element, a solvent, and a foaming agent.

14. The method of claim 13, wherein the applying of the composition comprises tape casting, comma coating, doctor blade coating, web coating, slot die coating, gravure coating, lip coating, cap coating, or bar coating.

15. The method of claim 13, wherein the preparing of the porous transport layer comprises:
preparing a base layer by applying the composition for the porous transport layer; and
preparing the porous transport layer by drying, degreasing, and sintering the base layer.

16. The method of claim 15, wherein the foaming agent is a pyrolytic chemical foaming agent, and wherein the drying is performed at a temperature lower than a pyrolysis temperature of the pyrolytic chemical foaming agent.

17. The method of claim 15, wherein the degreasing is performed at a temperature in a range from 500 to 800° C. under an inert gas atmosphere.

18. The method of claim 15, wherein the sintering is performed at a vacuum degree equal to or lower than 10⁻⁵ Torr or in a range from 900 to 1,300° C.
